(19) United States
(12) Patent Application Publication
(10) Pub. No.: US 2023/0223595 A1
(43) Pub. Date: Jul. 13, 2023

(54) Heterocyclic Electrolyte Additives for Rechargeable Metal Batteries

(71) Applicant: U.S. Army DEVCOM, Army Research Laboratory, Adelphi, MD (US)

(72) Inventors: Lin Ma, Silver Spring, MD (US); Marshall A. Schroeder, Pasadena, MD (US); Oleg A. Borodin, Laurel, MD (US); Travis P. Pollard, Rockville, MD (US); Kang Xu, Potomac, MD (US)

(21) Appl. No.: 17/573,178

(22) Filed: Jan. 11, 2022

(51) Int. Cl. H01M 10/0567

(52) U.S. Cl. CPC H01M 10/0567; H01M 2300/0025

(57) ABSTRACT

An electrochemical cell (such as a battery) that provides, inter alia, improved cycling efficiencies, by utilizing an electrolyte and a plurality of electrodes (including at least one metal electrode) where the electrolyte includes one or more solvents, one or more salts, and one or more additives, and at least one of the additives is a heterocyclic compound.

### BACKGROUND

Commercial applications of batteries with metal electrodes such as Zn are ubiquitous. However, most of these batteries are currently limited to primary (non-rechargeable) systems due to poor reversibility, or are rechargeable but with limited cycle life. The majority of electrolytes for these metal electrode batteries are water-based, and suffer from reactivity between, e.g., Zn and water, leading to corrosion, self-discharge, hydrogen evolution, dendrite growth, and other parasitic reactions, which reduce the efficiency of the battery. Even state of the art optimized aqueous/non-aqueous electrolyte formations are not capable of cycling metal batteries at reasonable areal capacities (e.g., >1 mAh cm⁻²) and current densities (e.g., >0.25 mA/cm²) with high Coulombic efficiency (CE) (e.g., CE>95%).

In order for rechargeable batteries with metal electrodes to be commercially viable, electrolytes with significantly higher Coulombic efficiencies (e.g., CE>99%) must be developed.

The embodiments herein may be manufactured, used, and/or licensed by or for the United States Government without the payment of royalties thereon.

### BRIEF SUMMARY

The present disclosure is drawn to providing such improved efficiencies, by including particular additives to the electrolytes.

A first aspect of the present disclosure is an electrochemical cell (such as a battery) that comprises an electrolyte and a plurality of electrodes in contact with the electrolyte. The electrolyte comprises one or more solvents, one or more salts, and one or more additives (preferably, the additives are present in a total amount of no more than 10% by weight of the electrolyte). At least one of the additives is a heterocyclic compound. The plurality of electrodes includes at least one electrode that comprises a metal exhibiting electrochemical activity. In some embodiments, the cell also includes a membrane (such as a proton exchange membrane) placed between the electrodes.

Advantageously, the heterocyclic compound is a five membered ring compound or a six-membered ring compound.

Preferably, the heterocyclic compound is a five-membered ring compound having 1-5 nitrogen atoms on the ring. In some embodiments, one of the nitrogen atoms on the ring is protonated or contains a functional group (such as a group comprising a fluorine or a hydroxyl group, or where the group is an ether or an alkene). In some embodiments, the functional group is —CF₃, or comprises a S—F bond. In some embodiments, the five-membered ring compound has at least one carbon on the ring attached to a functional group that is capable of forming a radical under reducing conditions, oxidizing conditions, and/or chemically with other electrolyte species, and is capable of subsequently undergoing radical condensation reactions.

Preferably, the five-membered ring compound or six-membered ring compound is an azole, an imidazole, a triazole, a tetrazole, a pyrazole, a pyridine, a pyrimidine, or a pyrrolidine. In some embodiments, it is an azole comprising a plurality of —CF₃, or —SF functional groups (such as, e.g., 3,5-bis(trifluoromethyl)-1H-pyrazole (TFMP)).

In some embodiments, the heterocyclic compound is a monocyclic compound.

Preferably, the heterocyclic compound has a molecular weight no more than 900 g/mol, and in some embodiments, the compound has a molecular weight no more than 300 g/mol.

The solvent may be an aqueous solvent, or a non-aqueous solvent. Advantageously, the non-aqueous solvent may comprise a protic or an aprotic solvent. Such protic or aprotic solvents may be, e.g., a carboxylate ester, a carbonate ester, an esters of an inorganic acid, an ether, a nitrile, a sulfone, an alkyl phosphate or an alcohol.

In some embodiments, the electrolyte is an ionic liquid-based electrolyte.

Advantageously, the salt is a salt anion comprising either a simple (i.e., monatomic) halide anion or a complex (i.e., polyatomic) anion, such as hexafluorophosphate (PF₆), tetrafluoroborate (BF₄), bis(oxalato)borate (BOB), tri[bis(trifluoromethane)sulfonimide] (TF SI), trifluoromethanesulfonate (OTf), a chloride, a sulfate, a nitrate, a bromide, a fluoride, a perchlorate or an acetate, or a combination thereof.

Advantageously, the metal comprises Li, Na, Mg, Al, Ca, Zn, or a combination thereof (including alloys thereof), and most preferably comprises Zn.

### BRIEF DESCRIPTION OF DRAWINGS

FIG. 1A is a graphical schematic of a protocol for determination of Coulombic efficiency of different electrolytes (e.g., Zn electrolytes), coinciding with potential as measured over time. When the potential is below 0V, Zn is being plated on the Cu working electrode. Above 0V, Zn is being stripped. CE is calculated as CE=(9Q_{C}+Q_{S})/(9Q_{C}+Q_{R}), a ratio representative of the amounts of Zn plated and stripped.

FIG. 1B is a graph of the measured potential of two electrolytes (0.5M Zn(TFSI)₂ in Propylene Carbonate (PC) and 0.5M Zn(TFSI)₂ in triethyl phosphate (TEP)) using the method illustrated in FIG. 1A.

FIGS. 1C and 1D are graphs of measured potential of state of the art systems (1M ZnSO₄ in H₂O (FIG. 1C) and 2M Zn(OTF)₂ in H₂O (FIG. 1D). These electrolytes are widely accepted as “good” Zn electrolytes but are unable to finish this protocol, suggesting that these state of the art systems have efficiencies that are too low to be commercially useful.

FIG. 2A is a graph of measured voltage over time for a cell with 1M Zn(TFSI)₂ in H₂O, for use in determining Coulombic efficiency.

FIG. 2B is a graph of measured voltage over time for a cell with 1M Zn(TFSI)₂ and 0.05M TFMP in H₂O, for use in determining Coulombic efficiency.

FIG. 3A is a graph illustrative of cycle life of a cell with 1M Zn(TFSI)₂ in H₂O.

FIG. 3B is a graph illustrative of cycle life of a cell with 1M Zn(TFSI)₂ and 0.05M TFMP in H₂O.

FIG. 4A is a graph of measured voltage over time for a cell with 1M Zn(TFSI)₂ in Acetonitrile for use in determining Coulombic efficiency.

FIG. 4B is a graph of measured voltage over time for a cell with 1M Zn(TFSI)₂ and 0.05M TFMP in Acetonitrile, for use in determining Coulombic efficiency.

### DETAILED DESCRIPTION

Embodiments of the present disclosure are described in detail with reference to the figures wherein like reference numerals identify similar or identical elements. It is to be understood that the disclosed embodiments are merely examples of the disclosure, which may be embodied in various forms. Well known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The term “electrochemical cell” or “cell” as used herein is intended to refer to a device that converts chemical energy into electrical energy, and/or electrical into chemical energy. Generally, cells will have two or more electrodes and an electrolyte, and in use, reactions occurring at the surface of the electrodes results in charge transfer processes.

The term “electrode” may refer to a “cathode” or an “anode”. The terms “cathode” refers to the electrode having the higher of electrode potential in an electrochemical cell (i.e., higher than the anode). Conversely, the term “anode” refers to the electrode having the lower of electrode potential in an electrochemical cell (i.e., lower-than the cathode). Cathodic reduction refers to a gain of electron(s) of a chemical species, and anodic oxidation refers to a loss of electron(s) of a chemical species.

The term “electrolyte” refers to an ionic conductor which may be, e.g., in a solid state (including a gel), or in a liquid state. Generally, electrolytes are present in the liquid state.

The term “solvent” as used herein is intended to refer to a liquid that at least substantially or completely dissolves a solid, liquid, or gaseous solute, resulting in a solution. Liquid solvents can dissolve electron acceptors and electron donor metals in order to facilitate transfer of electrons from the electron donor metal to the electron acceptor.

Disclosed is an electrochemical cell, and preferably a battery, and more preferably a rechargeable battery. The electrochemical cell, battery, or rechargeable battery comprises an electrolyte and a plurality of electrodes in contact with the electrolyte. The electrolyte contains at least one heterocyclic compound as an additive.

The electrolyte is preferably an electrolyte solution comprising a solvent, a salt, and an additive. In some embodiments, the electrolyte consists of one or more solvents, one or more salts, and one or more additives. In some embodiments, the electrolyte comprises a plurality of solvents, a plurality of salts, a plurality of additives, or a combination thereof In some preferred embodiments, the electrolyte consists of a solvent, a salt, and a plurality of additives. In some embodiments, the electrolyte is anhydrous.

### Solvent

Any appropriate solvent for an electrochemical cell may be utilized here. In some embodiments, the solvent is an aqueous solvent. In some embodiments, the solvent is a non-aqueous solvent. In some embodiments, the solvent is a polar solvent, and may be a protic solvent or an aprotic solvent. In some embodiments, a protic and aprotic solvent are used. The protic and aprotic solvents may be, e.g., a carboxylate ester, a carbonate ester, an esters of an inorganic acid, an ether, a nitrile, a sulfone, a alkyl phosphate or an alcohol. Non-limiting examples of such solvents include, e.g., methyl proprionate, ethylene carbonate, dimethyl sulfate, tetrahydrofuran (THF), acetonitrile, tetramethyl sulfone, ethanol, or a polyol such as a glycerol.

In some embodiments, the solvent is an organic solvent.

In some embodiments, the solvent comprises an ionic liquid (IL). Ionic liquids can generally be understood as salts in a liquid state. For example, in one embodiment, the liquid comprises cyano-based anions (dicyanamide, DCA⁻ and tricyanomethanide, TCM⁻) with a pyrrolidinium cation. In some preferred embodiments, the ionic liquid comprises a bis(trifluoromethanesulfone)imide (TFSI) anion.

Non-limiting examples of suitable ionic liquids may include, but not limited to, 1-butyl-3-methylimidazolium trifluoroacetate, 1-butyl-1-methylpyrrolidinium trifluoroacetate, 1-butyl-2,3-dimethylimidazolium bis(trifluoromethylsulfonyl)imide, 1-butyl-3-methylimidazolium bis(trifluoromethylsulfonyl)imide, 1-butyl-2,3-dimethylimidazolium tetrafluoroborate, 1-butyl-3-methylimidazolium tetrafluoroborate, 1-butyl-3-methylimidazolium tetrafluoroborate, N-butyl-3-methylpyridinium tetrafluoroborate, 1-butyl-3-methylimidazolium dicyanamide, N-butyl-3-methylpyridinium dicyanamide, 1-butyl-1-methylpyrrolidinium dicyanamide, 1-ethyl-3-methylimidazolium thiocyanate, 1-benzyl-3-methylimidazo hum chloride, 1-butyl-3-methylimidazolium tricyanomethane, N-butyl-3-methylpyridinium dicyanamide, 1-butyl-1-methylpyrrolidinium dicyanamide, 1-ethyl-3-methylimidazolium hydrogensulfate, N-butyl-3-methylpyridinium hexafluorophosphate, 1-butyl-2,3-dimethylimidazolium hexafluorophosphate, 1-butyl-3-methylimidazolium methanesulfonate, N-butyl-3-methylpyridinium trifluoromethanesulfonate, 1-butyl-2,3-dimethylimidazolium trifluoromethanesulfonate, 1-butyl-3-methylimidazolium trifluoromethanesulfonate, 1-butyl-3-methylimidazolium trifluoromethanesulfonate, guanidinium trifluoromethanesulfonate, guanidinium tris(pentafluoroethyl)trifluorophosphate, 1-benzyl-3-methylimidazolium chloride, 1-butyl-3-methylimidazolium methanesulfonate, 1-butyl-2,3-dimethylimidazolium bis(trifluoromethylsulfonyl)imide, trihexyl(tetradecyl)phosphonium bis[oxalato(2-)]borate, trihexyl(tetradecyl)phosphonium bis(trifluoromethylsulfonyl)imide, trihexyl(tetradecyl)phosphonium tris(pentafluoroethyl)trifluorophosphate, N-butyl methylpyridinium bromide, N-butyl-3-methylpyridinium hexafluorophosphate, N-butyl methylpyridinium trifluoromethanesulfonate, 1-butyl-1-methylpyrrolidinium bromide, 1-butyl methylpyrrolidinium bis[oxalato(2-)]borate, or 1-butyl-1-methylpyrrolidinium bis(trifluoromethylsulfonyl)imide.

### Salt

Any appropriate salt may be used for the electrochemical cell. As is understood in the art, the salt will generally comprise a cation and a counter anion, configured such that salt is charge neutral (e.g., having a net charge of zero). In preferred embodiments, the salt is a metal salt.

In some embodiments, the salt cation may be a cation of an alkali metal, an alkali-earth metal, a transition metal, or a post-transition metal. Most preferably, the metal is the same metal that comprises one of the plurality of electrodes in the cell. For example, if one electrode is a Zn electrode, the salt is a Zn salt.

In some embodiment, the salt is an organic salt. In some of these embodiments, the salt cation may include, but is not limited to: 1-ethyl-3-methyl-imidazolium, ([Emim]+), 1-butyl-3-methyl-imidazolium ([Bmim]+), 1-hexyl-3-methyl-imidazolium ([Hmim]+), 1-butyl-3-methylpyridinium ([BMPy]+), 1-benzyl-3-methyl-imidazolium ([Bzmim]+), and Trihexyltetradecylphosphonium ([P666(14)]+).

In some embodiments, the salt anion comprises either a halide anion or a polyatomic anion.

Salt anions include, but are not limited to: tetrafluoroborate ([BF₄]−), hexafluorophosphat ([PF₆]−), bis(oxalato)borate ([BOB]−), Cl-, Br-, I-, [ClO₄]−, [HSO₄]−, [H₂PO₄]−, [NO₃]−, an acetate ion ([Ac]−), trifluoroacetic acid ion ([TFA]−), trifluoromethanesulfonate ([TFS]−), [BF₃Cl]−, [SCN]−, or dicyanamide ([DCA]−).

In some preferred embodiments, the salt anion is an anion of hexafluorophosphate (PF₆), tetrafluoroborate (BF₄), bis(oxalato)borate (BOB), bis(trifluoromethane)sulfonimide ([TFSI]), trifluoromethanesulfonate, a chloride, a sulfate, a nitrate, a bromide, a fluoride, a perchlorate or an acetate, or a combination thereof.

In some preferred embodiments, the solvent comprises or consists of an IL and the salt comprises or consists of a metal salt.

### Additive

The electrolyte also contains at least one additive. The additive is a heterocyclic compound. The total amount of additive present in the electrolyte is preferably no more than 10% by weight of the electrolyte.

Preferably, the heterocyclic compound is a five- or six-membered ring compound. Non-limiting examples of preferred five-membered ring compounds includes azoles, imidazoles, triazoles, tetrazoles, and pyrazoles. Non-limiting examples of preferred six-membered ring compounds include pyridines, pyrimidines, and pyrrolidines.

More preferably, the heterocyclic compound is a five-membered ring compound having 1-5 nitrogen atoms on the ring. Preferably, one of the nitrogen atoms on the ring is protonated or contains a functional group. In some embodiments, the functional group comprises a fluorine or a hydroxyl group, or is an ether or an alkene. In some embodiments, the functional group is —CF₃ or is a functional group comprising a S—F bond (e.g., —SF₂, —SF₄, —SF₂₀, etc.).

In addition to five-membered rings having 1-5 nitrogen atoms on the ring, the heterocyclic compound also preferably has at least one carbon on the ring attached to a functional group that is capable of forming a radical under reducing conditions, oxidizing conditions, and/or chemically with other electrolyte species or with solid electrolyte interphase compounds such as ZnO, and is capable of subsequently undergoing radical condensation reactions.

In some embodiments, the electrolyte species that may be involved in a chemical reaction with the functional group include additive anions and fragments resulting from chemical or electrochemical degradation of the additive anions (such as TFSI or OTf anion decomposition products), Further, In some embodiments, these additive species may also dimerize (if only 1 carbon with CF3 moeity is present on the ring) or oligomerize/polymerize with themselves (if 2+ CF3 moeities are present on the ring). In some embodiments, the proton from an NH group may have functionality in reducing oxide film resistance through hydroxylation. In some embodiments, there may be similar reactions at the cathode.

Non-limiting examples of such functional groups for reactivity with other additive species in solution include: CF₃, S—F, ethers, and alcohol functional groups, or other polyatomic anion species bonded to the ring. Non-limited examples of such functional groups for the non-additive electrolyte components include: CF₃, S—F, olefins, carbonyls, ethers, and alcohol functional groups.

In some embodiments, the five- or six-membered ring has halogens or a polyatomic anion directly attached to the ring. For example, one embodiment of a heterocyclic compound is 4-(4,4,5,5-tetramethyl-1,3,2-dioxaborolan-2-yl)-3,5-bis(trifluoromethyl)-1H-pyrazole.

Preferably, the electrochemical cell according to claim 17, wherein the five-membered ring compound or six-membered ring compound is an azole comprising a plurality of —CF₃ functional groups and/or functional groups comprising S—F bonds. For example, one preferred heterocyclic compound is 3,5-bis(trifluoromethyl)-1H-pyrazole (TMFP).

In preferred embodiments, the heterocyclic compound is a monocyclic compound.

The heterocyclic compound is preferably a small molecule, having a molecular weight no more than 900 g/mol. In some preferred embodiments, the molecular weight is no more than 300 g/mol.

The electrochemical cell also comprises a plurality of electrodes, including at least one metal electrode. The metal can be any metal that exhibits electrochemical activity. In preferred embodiments, the metal comprises an alkali metal, an alkali-earth metal, a transition metal, a post-transition metal, or a combination thereof. In more preferred embodiments, the metal comprises Li, Na, Mg, Al, Ca, Zn, or a combination thereof. In some embodiments, the metal is free of Lithium. In a most preferred embodiment, the metal comprises Zn. In some embodiments, the metal electrode is an alloy of one of the aforementioned metals.

The other electrodes may be additional metal electrodes as described above, or may be comprised of any other material capable of being used in an electrochemical cell.

The addition of the class of additives disclosed herein to an electrolyte significantly improves cycling Coulombic efficiency (CE) and long term cycling stability of metal test cells as compared to performance of the baseline electrolyte system.

Coulombic efficiency (CE) is defined as the ratio of the discharge capacity to the prior charge capacity. That is, CE is the fraction of energy (metal/electrons) you can get back out compared to what you've put into the system (metal/electrons).

### Other Additives

In addition to the additives disclosed above, it is understood that other additives may be included.

In some embodiments, the electrolyte may also comprise an organic additive.

Such additional organic additives may comprise, e.g., one or more alkyl quaternary ammonium compounds, such as aliphatic quaternary ammonium compounds. In some embodiments, the organic additive can include an ammonium bromide salt. Non-limiting examples of ammonium bromide salt additives includes hexadecyltrimethyl ammonium bromide (CTAB), ammonium bromide, tetrapropylammonium bromide, terakis(decyl)ammonium bromide, (12-Dodecylphosphonic acid)N,N-Dimethyl-N-octadecyl ammonium bromide, trimethyltetradecylammonium bromide, myristyltrimethylammonium bromide, domiphen bromide, (1-(4-methoxy-benzoyl)-undecyl)trimethyl-ammonium bromide, (2-dodecanoylamino-ethyl)-dimethyl-tetradecyl-ammonium bromide, 3-benzyl-3H-b enzothiazol-2-ylidene-ammonium bromide, acetyl-benzyl-diethyl-ammonium bromide, allyloxycarbonylmethyl-ethyl-ammonium bromide, allyloxycarbonylmethyl-trimethyl-ammonium bromide, benzyloxycarbonylmethyl-triethyl-ammonium bromide, benyloxycarbonylmethyl-trimethyl-ammonium bromide, bis-decyl-diethyl-ammonium bromide, decyl-dimethyl-(2,3,4,5,6-pentahydroxy-hexyl)-ammonium bromide, decyl-tris-(2-decyloxy-ethyl)-ammonium bromide, dibenzyl-methoxycarbonylmethyl-ammonium bromide, diethylmethyl(2-(3-methyl-2-phenylvaleryloxy)-ethyl) ammonium bromide, trimethyl(2,4,5-trimethylbenzyl)ammonium bromide, trimethyl-(2-oxo-benzothiazol-3-ylmethyl)-ammonium bromide, stearyltrimethyl ammonium bromide, tetrabutylammonium bromide, sodium dodecyl trimethyl ammonium bromide, or a combination thereof.

In some embodiments, the additional organic additives may include sodium dodecyl benzene sulfonate (SDBS), salicylaldehyde (SAL), benzylideneacetone (BDA), benzylacetone (BA) and/or butylbenzene (BB) additives.

In some embodiments, the additional organic additives may comprise tetramethyl-ammonium chloride (TMAC) and/or tetrabutyl-ammonium (TBAC).

In some embodiments, the additional organic additives can comprise benzyl alcohol, benzyl chloride, decylamine (DA), sorbitol, aniline, or any combination thereof.

In some embodiments, additional organic additives may comprise a surfactant, such as a perfluorinated cationic, anionic, or nonionic surfactant (e.g., Forafac™ F1110 surfactant (C₆F₁₃C₂H₄(OC₂H₄)₁₂OH) (from Atochem), an anionic surfactant (e.g., FC-129) or a cationic surfactant (e.g., FC-135), Triton™ X-100 surfactant from Dow, sodium methylene bis (naphthalene sulfonate) (NNO), phenylbenzylketone (PBK), sodium dodecyl sulfate (SDS), sodium lauryl sulphate (SLS), sodium dodecyl benzene sulphonate, or any combination thereof.

In some embodiments, the additional organic additives can comprise some polymer compounds, such as polyethylene glycol (PEG) with different molecular weight (PEG 200, PEG 300, PEG 400, PEG 600, PEG 900, PEG 1000, PEG 3000, PEG 10000 and PEG 20000), polyethylene oxide with different molecular weight, dicarboxylic acid modified PEG, polypropylene glycol (PPG) 725, terathane, PEG dodecyl ether, PEG diacid 600, polyoxyethylene alkyl phosphate ester acid (GAFAC RA 600), polyacrylamide thiourea, cellulose, or any combination thereof.

### EXAMPLE 1

### Measuring Coulombic Efficiency

In this example, a Cu—Zn cell setup was used, with Cu as the working electrode and Zn as the counterelectrode, Zn source, and reference. The Cu is cycled galvanostatically (a constant current) to plate the Zn to a certain capacity, at which point the current is reversed and the Zn is stripped from the copper.

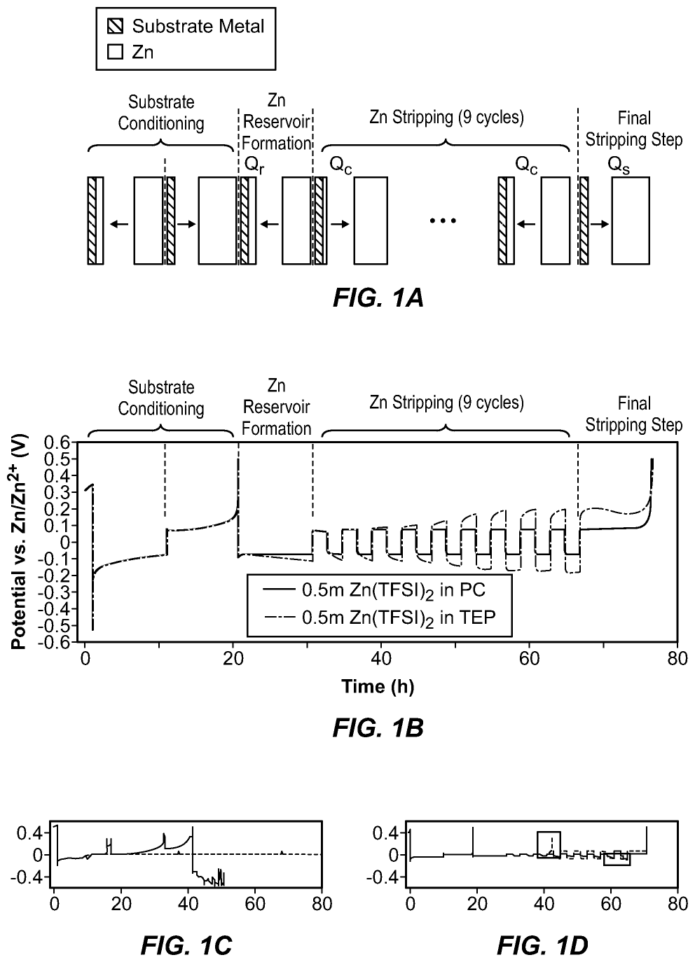

Referring to FIGS. 1A and 1B, a graphical illustration (FIG. 1A) of a specific procedure for testing Coulombic efficiency is shown, with potentially measured over time (FIG. 1B) of two example cells tested using the procedure. One cell used 0.5M Zn(TFSI)₂ in PC, the other used 0.5M Zn(TFSI)₂ in TEP. Generally, in this example procedure, when the measured potential is below 0V, Zn is being plated on the working electrode, and when the measured potential is above 0V, Zn is being stripped.

Substrate effects (lattice mismatch, alloying, interphase effects, etc.) are mitigated by an initial substrate conditioning cycle, in which 5 mAh cm⁻² of Zn is plated on and stripped from the Cu working electrode. Following this substrate conditioning step, a Zn reservoir formation step occurs, where a 5 mAh cm⁻² “Zn reservoir” is subsequently plated on the Cu to provide a quantitatively limited and well-controlled source of Zn for accurate CE determination (QR). A fraction of this plated Zn reservoir (approximately 20%) is then cycled nine times at a fixed capacity of 1 mAh cm⁻² (Qc) at a rate of 0.5 mA cm⁻², followed by stripping to a preselected upper cut-off voltage (0.5 V vs Zn/Zn2+), at which all removable Zn should be stripped, including the initial reservoir (Qs). The CE is calculated as CE=(9Q_{C}+Q_{S})/(9Q_{C}+Q_{R}). In this protocol, a moderate current density and a modest number of cycles were deliberately selected to avoid anomalous CE measurements from effects such as Zn dendrite formation or excessive impedance growth. Electrolytes that allow for more Zn to be reversibly plated/stripped have a higher CE, and are more commercially viable for rechargeable Zn metal batteries.

The relation between Coulombic efficiency and cycle life is generally understood as (CE)^{N}=Capacity Retained at N Cycles. That is, if a cell has a Coulombic Efficiency of 90% and it is cycled 5 times, only 59% of the capacity is retained. If the CE is improved to 95% and the cell is cycled 5 times, 77% of the capacity is retained, a massive increase.

### EXAMPLE 2

### Effect of Disclosed Additive On CE

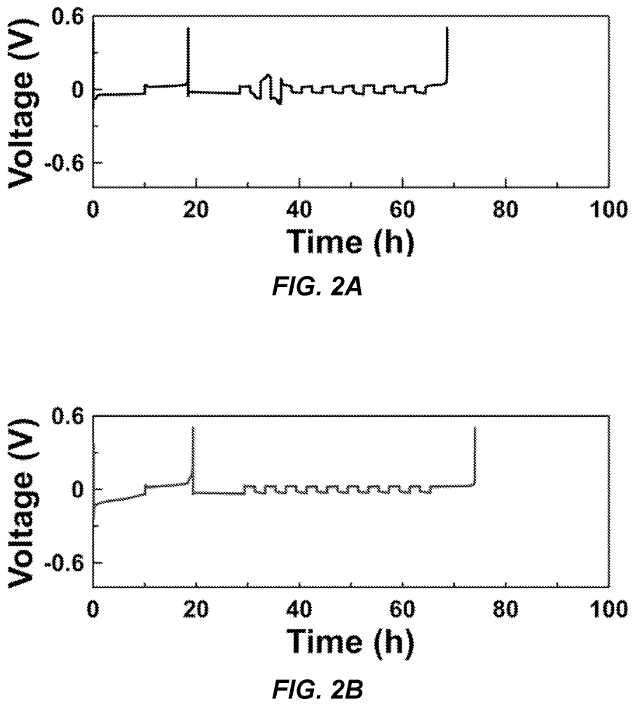

Referring to FIGS. 2A and 2B, this example utilizes the addition of a small amount of 3,5-Bis(trifluoromethyl)-1H-pyrazole TMFP (see FIG. 2B) to a common Zn aqueous electrolyte (1M Zn(TFSI)₂ in H₂O) (see FIG. 2A) to increase the measured cycling efficiency of a Zn I Cu test cell at room temperature from 79.2% to —95.19%. The procedure aligned with the procedure in Example 1, where both the conditioning step and the reservoir formation step plated/stripped 5 mAh/cm², at a rate of 0.5 mA/cm². The cycling steps cycled 1 mAh/cm² at a rate of 0.5 mA/cm², and the final stripping was done at 0.5V. This improvement due to the addition of a disclosed additive to the electrolyte—seen by comparing FIG. 2A to FIG. 2B—translates to a major improvement in cycle life and commercial viability in full cells.

### EXAMPLE 3

### Effect of Additive on Cycle Life

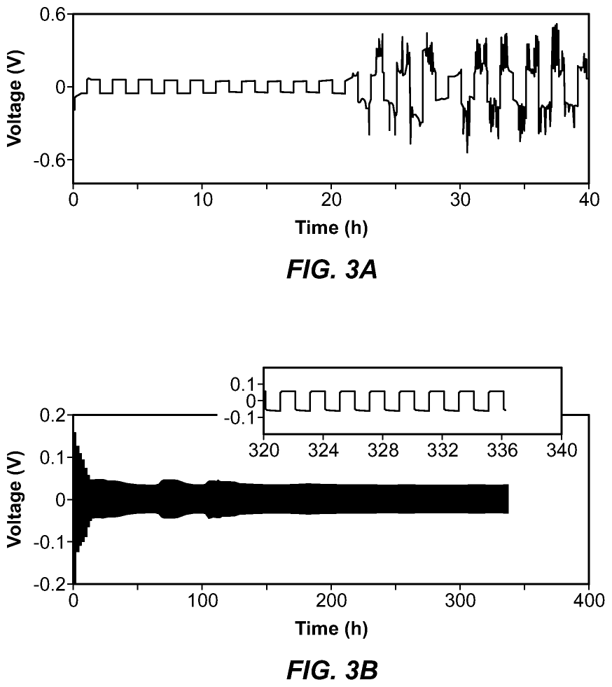

In this example, to test the effect on cycle life, a symmetric Zn|Zn cell at room temperature, using cycles of 1 mAh/cm² at a rate of 1 mA/cm², was shown to have an almost 17X improvement in cycling lifetime, increasing cycling stability from—20 hours to more than —340 hours for the additive-containing electrolyte compared to the baseline system. This can be seen by comparing FIGS. 3A and 3B. Specifically, As is seen in FIG. 3A, the baseline electrolyte failed after only a little over 20 hours, while the electrolyte containing the additive (the graph here was with 0.05M TFMP, but similar results were seen with many other disclosed additives) ran until the experiment was stopped just shy of 340 hours.

### EXAMPLE 4

### Non-Aqueous Electrolytes

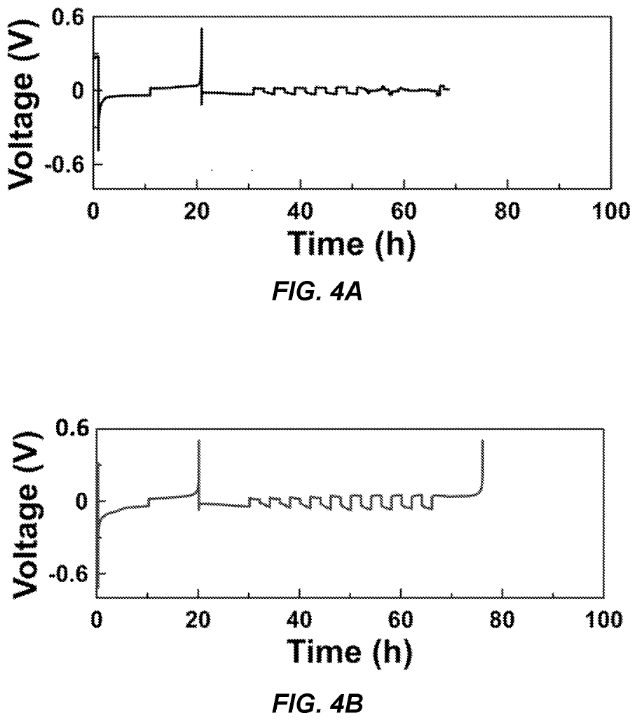

Referring to FIGS. 4A and 4B, the utility of these types of additives in non-aqueous electrolytes can be seen, with a Zn|Cu test cell. In FIG. 4A, the measured voltage over time for a 0.5 m Zn(TFSI)₂ in Acetonitrile is shown, using a cycling procedure as described in Example 2. FIG. 4B shows the measured voltage when 0.05M TFMP is added as an additive to the electrolyte. The baseline (FIG. 4A) is unable to finish the test protocol, while mixtures with the disclosed additives (FIG. 4B) exhibit extremely high efficiencies (here, efficiencies of 99.96%).

Such efficiencies indicate this anode could cycle upwards of 1000 times with a capacity of 80%, suggesting impressive commercial viability.

Those skilled in the art will recognize or be able to ascertain using no more than routine experimentation many equivalents to the specific embodiments of the invention described herein. Such equivalents are intended to be encompassed by the following claims.

What is claimed is:

1. An electrochemical cell, comprising:
an electrolyte comprising a solvent, a salt, and an additive; and
a plurality of electrodes in contact with the electrolyte, the plurality of electrodes including a first electrode comprising a metal exhibiting electrochemical activity,
wherein the additive is a heterocyclic compound or a mixture of more than one heterocyclic compounds.

2. The electrochemical cell according to claim 1, wherein the electrochemical cell is a battery, the electrolyte is an ionic liquid electrolyte, the solvent is an aqueous solvent, the additive is present in a total amount that is no more than 10% by weight of the electrolyte, or a combination thereof.

3. The electrochemical cell according to claim 1, wherein the solvent is a non-aqueous solvent.

4. The electrochemical cell according to claim 3, wherein the non-aqueous solvent comprises a protic or an aprotic solvent, or a hybrid of a protic and an aprotic solvent.

5. The electrochemical cell according to claim 4, wherein the protic or aprotic solvent is a carboxylate ester, a carbonate ester, an esters of an inorganic acid, an ether, a nitrile, a sulfone, or an alcohol.

6. The electrochemical cell according to claim 1, wherein the salt comprises a salt anion, the salt anion comprising either a halide anion or a polyatomic anion.

7. The electrochemical cell according to claim 6, wherein the salt anion is hexafluorophosphate (PF6), tetrafluoroborate (BF4), bis(oxalato)borate (BOB), tri[bis(trifluoromethane)sulfonimide] (TFSI), trifluoromethanesulfonate, a chloride, a sulfate, a nitrate, a bromide, a fluoride, a perchlorate or an acetate, or a combination thereof.

8. The electrochemical cell according to claim 1, wherein the heterocyclic compound is a five membered ring compound or a six-membered ring compound.

9. The electrochemical cell according to claim 8, wherein the heterocyclic compound is a five-membered ring compound having 1-5 nitrogen atoms on the ring.

10. The electrochemical cell according to claim 9, wherein one of the nitrogen atoms on the ring is protonated or contains a functional group.

11. The electrochemical cell according to claim 10, wherein the functional group comprises a fluorine or a hydroxyl group, or is an ether or an alkene

12. The electrochemical cell according to claim 11, wherein the at least one functional group comprising a fluorine is —CF₃ or comprises a S—F bond.

13. The electrochemical cell according to claim 9, wherein the five-membered ring compound has at least one carbon on the ring attached to a functional group that is capable of forming a radical under reducing conditions, oxidizing conditions, and/or chemically with other electrolyte species, and is capable of subsequently undergoing radical condensation reactions.

14. The electrochemical cell according to claim 8, wherein the five-membered ring compound or six-membered ring compound is an azole, an imidazole, a triazole, a tetraazole, a pyrazole, a pyridine, a pyrimidine, or a pyrrolidine.

15. The electrochemical cell according to claim 14, wherein the five-membered ring compound or six-membered ring compound is an azole comprising a plurality of —CF₃, or —SF functional groups.

16. The electrochemical cell according to claim 15, wherein the azole is 3,5-bis(trifluoromethyl)-1H-pyrazole (TFMP).

17. The electrochemical cell according to claim 1, wherein heterocyclic compound is a monocyclic compound, has a molecular weight no more than 900 g/mol, or both.

18. The electrochemical cell according to claim 17, wherein the heterocyclic compound has a molecular weight no more than 300 g/mol.

19. The electrochemical cell according to claim 1, wherein the electrolyte comprises a plurality of solvents, a plurality of salts, a plurality of additives, or a combination thereof.

20. The electrochemical cell according to claim 1, wherein the metal comprises Li, Na, Mg, Al, Ca, Zn, or a combination thereof
